(19) United States
(12) Patent Application Publication
(10) Pub. No.: US 2010/0145572 A1
(43) Pub. Date: Jun. 10, 2010

(54) METHOD FOR SUPPORTING THE AUTOMATION OF AGRICULTURAL WORK OR SERVICE

(76) Inventors: Thilo Steckel, Guetersloh (DE); Andre Kluge, Guetersloh (DE)

Correspondence Address: Striker, Striker & Stenby, 103 East Neck Road, Huntington, NY, 11743, US

(21) Appl. No.: 12/634,437

(22) Filed: Dec. 9, 2009

(30) Foreign Application Priority Data
Dec. 10, 2008 (DE) 10 2008 061 252.9

(51) Int. Cl. G06F 7/00; G06Q 10/00; G06Q 50/00

(52) U.S. Cl. 701/33; 701/29; 701/50; 705/1.1

(57) ABSTRACT

A method for supporting the automation of agricultural work or service includes collecting data, further processing the collected data using context processing rules to form a context profile, selecting process information using process assignment rules and depending on the context profile, and performing agricultural work or service depending on the process information that was selected, so that it is possible to largely automate the performance of agricultural work or service.

### CROSS-REFERENCE TO A RELATED APPLICATION

The invention described and claimed hereinbelow is also described in German Patent Application DE 10 2008 061 252.9 filed on Dec. 10, 2008. This German Patent Application, whose subject matter is incorporated here by reference, provides the basis for a claim of priority of invention under 35 U.S.C. 119(a)-(d).

### BACKGROUND OF THE INVENTION

The present invention relates to a method for supporting the automation of agricultural work or service, which includes the step of collecting data.

The present invention furthermore relates to an agricultural machine which includes a control unit designed to perform agricultural work or service depending on process information, one or more data collection device which are designed to collect data, and a system for supporting the automation of agricultural work or service, which includes a transmitter unit and a receiver unit which are designed to communicate with one or more agricultural machines.

In agriculture, various forms of agricultural work or service should be performed as efficiently as possible. Agricultural work or service of this type may include harvesting work and other types of work, such as harvesting a cultivated field, recovering crop material, performing the further processing of crop material, soil management, applying auxiliary substances, etc.

A user, e.g., an operator of an agricultural machine or the operator of an agricultural enterprise, typically must perform a large number of actions in order to perform agricultural work or service. Attempts are therefore made to simplify the performance of agricultural work or service, in order to increase the efficiency of agricultural work or service.

To this end, DE 10 2004 034 799 A1 describes a communication system for mobile and stationary devices which include at least one transmitter/receiver unit, in which case the transmitter/receiver unit has a defined transmission/reception range, and the at least partial overlap of the transmission/reception ranges of the mobile and/or stationary devices results in accidental communication between them, and this accidental communication changes to deliberate communication. This system may contribute to simplifying communication between mobile and stationary devices, e.g., in a harvesting chain. However, there is still a need for improvement in terms of performing agricultural work or service more efficiently.

DE 10 2004 043 169 A1 describes a system based on electronic data exchange for obtaining information to implement processes, characterized by the fact that the information is obtained using at least one application, and that the application obtains situation-specific information. A user of the information gathering system may therefore be at least partially relieved of the task of gathering information in a qualified manner, which may simplify the performance of agricultural work or service. However, there is still a need to further simplify the performance of agricultural work or service.

Overall, a demand therefore exists for a method that simplifies the performance of agricultural work or service, and/or that makes it possible to perform agricultural work or service more efficiently. Demand likewise exists for a method that reduces the number of errors that occur during the performance of agricultural work or service.

### SUMMARY OF THE INVENTION

The object of the present invention, therefore, is to overcome the disadvantages of the prior art and, in particular, to at least partially meet the demand described above.

This object is attained via a method described initially, and which is characterized by the following steps:
Further process the collected data using context processing rules, to form a context profile,
Select process information using process assignment rules and depending on the context profile, and
Perform agricultural work or service depending on the process information that was selected.

The solution according to the present invention is based on the finding that the performance of agricultural work or service depends on the particular context. In the sense of the present invention, a context is described by a context profile. A context profile is a quantity of data which characterize, e.g., a certain situation or certain environmental or basic conditions. As described below, a context profile may build upon, e.g., sensor-based data on identity, geographic position, and the operating state of an agricultural machine. The use of context processing rules means that the collected data are processed further in a rule-based manner. Context processing rules may contain information of the type “If A, then B”, and they may be general rules, based on which conclusions may be drawn for specific situations. The context processing rules may be created, modified, and/or deleted by one or more users.

In terms of an agricultural machine, the collected data may state, e.g., that the agricultural machine is a combine harvester that is located at a certain position at a certain point in time, and that travels at a certain speed. An interpretation of these data based on context processing rules may result, e.g., in a context profile that states that this combine harvester is ready to harvest a field.

For a self-propelled forage harvester, the collected data may include, e.g., identity and time, as well as the geographic position, the operating state, the engine, main drive, and working position. Using context processing rules, the context “process time” may be derived for the self-propelled forage harvester if the geographic position of the forage harvester coincides with the geographic position of a field to be harvested, if the position of the harvester on the field changes, i.e., the harvester is moving, and the engine, main drive, and working drive are switched on.

Agricultural work or service in the sense of the present invention refers, e.g., to harvesting work and other forms of work, such as harvesting a cultivated field, recovering crop material, processing crop material further, working the ground, applying auxiliary substances, etc. Agricultural work or service in the sense of the present invention may also include work components or work modules, such as cutting, turning, deposting swaths, chopping, hauling, and storing.

Agricultural work or service in the sense of the present invention may be performed within an organization or across more than one organization. Agricultural work or service is performed within an organization, e.g., when a farmer performs harvesting work within his own enterprise. Agricultural work or service is performed across more than one organization, e.g., when an agricultural service provider, such as a contractor, performs harvesting work for a land manager or a communal organization.

Agricultural work or service may be performed, e.g., by agricultural machines. Agricultural machines in the sense of the present invention may be any type of agricultural harvesting or work machine, vehicles used in agriculture, and equipment therefor. Agricultural machines in the sense of the present invention are, e.g., harvesting machines, ground working machines, fertilizing and sowing units, tractors in combination with, e.g., hauling trailers or flatbed trailers, or baling presses, combine-mounted devices or front attachments

As described below, process information in the sense of the present invention includes, e.g., performing agricultural work or service, operating parameters therefore, and/or controlling information flows. In particular, process information may also be used to control an agricultural machine, i.e., to perform agricultural work or service using an agricultural machine based on the process information. Process information in the sense of the present invention also includes the management services required to perform agricultural work or service, such as documenting and calculating harvest or work output, controlling information flows, e.g., between agricultural machines and a farm management system, or controlling the type and quantity of data to be collected and/or stored.

In the solution according to the present invention, process information, for example, based on which the agricultural machine is controlled, is selected depending on the previously determined context profile using process assignment rules. This means that the process to be carried out by an agricultural machine depends on the context in which the agricultural machine is situated. The process assignment rules determine which process information is important for the agricultural machine given its context profile. The use of process assignment rules means that process information is selected in a rule-based manner. Process assignment rules may contain information of the type “If A, then B”, and they may be general rules, based on which conclusions may be drawn for specific situations. The process assignment rules may be created, modified, and/or deleted by one or more users.

For example, in the case of the first example mentioned, in which a combine harvester drives onto a field to be harvested, the process information “harvest the field at a certain ground speed” is an option, but not the process information “chop with a certain length of cut”. The process assignment rules ensure that only process information that is relevant to the particular context profile is selected.

In the second example, for the self-propelled forage harvester having the context “process time”, the process information may be selected, for example, that the data on the length-of-cut setting and the ground speed should be collected and stored for as long as the “process time” context persists.

The present invention is furthermore based on the finding that the context-based selection of process information makes it possible to largely automate the performance of agricultural work or service, thereby simplifying the performance of agricultural work or service and making it more efficient, while reducing the number of errors that occur. Given that the collected data are processed further or supplemented using context processing rules in order to form context profiles, and that process information is selected based on process assignment rules, the need for user input may be reduced considerably.

The elaborate inputs required by the user per the prior art before any agricultural work or service is performed, e.g., activate a map of a cutting area, navigate to a certain cutting area on the map, and define the tasks to be performed, may therefore be eliminated in the method according to the present invention. Instead, the agricultural machine may autonomously determine its context profile depending on collected data, such as its identity, position, and operating state, and on time information, and, based on the context profile, select and implement process information without a user having to provide additional information. This is a tremendous relief to a user, who, in the sense of the present invention, may be a land manager, a contractor, or a machine operator.

In the first example described above, it is not necessary, e.g., for a user to select the relevant cutting area in the map of cutting areas, nor to define the actions to be performed, since the context profile of the agricultural machine contains the geographic position and, based thereon, it is determined, with reference to context processing rules, in which cutting area it is located, and, based on the context profile of the agricultural machine and furthermore with reference to the process assignment rules, it is determined which process information should be applied. In the second example mentioned above, it is not necessary, e.g., for a user to manually initiate the documentation of length of cut and ground speed. In this manner, it is also possible to avoid errors, such as collecting incorrect data, inadequate data, or starting data collection too late.

Since the context processing rules and the process assignment rules are preferably checked for accuracy and completeness, the context profiles are determined and the process information is selected in a manner that, advantageously, is less error-prone than are manual determination and selection by a user. When input and retrieval are performed manually, errors are more likely to occur given the large quantity of information required, and, it is difficult for a user to interpret a large quantity of information correctly. The rule-based determination of context profiles according to the present invention, and the likewise rule-based selection of process information based on context profiles, likewise according to the present invention, eliminate the possibility that the user will make erroneous inputs and interpretations of a large quantity of data. The method according to the present invention may therefore also advantageously contribute to an increase in the quality and reliability of the performance of agricultural work or service, since it may be made impossible for a user to select incorrect process information or adjust process parameters in an inefficient manner.

The method according to the present invention has the further advantage that a large number of data may be processed into context profiles very quickly, and that process information may be selected from among a large amount of process information. In addition, the selection of process information and process parameters no longer depends on the experience and knowledge of a user. Preferably, the process information that is provided already contains information that has been optimized for the particular context profile, thereby ensuring that agricultural work or service is performed as efficiently as possible.

The method according to the present invention therefore makes it possible to largely automate the performance of agricultural work or service, since the system according to the present invention converts the collected data into context profiles in a rule-based manner, and, likewise in a rule-based manner, supplies the agricultural machine with process information that has been adapted for its actual context. User interactions are largely reduced and/or may be eliminated entirely via the method according to the present invention.

The present invention may be enhanced in that the data are collected at least partially using data collection devices in an agricultural machine. Data collection devices in an agricultural machine are, e.g. sensors or the fieldwork computer of an agricultural machine. A context is described, in the sense of the present invention, by a context profile that builds on data that are preferably collected by an agricultural machine, e.g., using certain sensors. A sensor may register material properties such as moisture content, or operating parameters such as length of cut. Data on ground speed, for example, may be retrieved from the fieldwork computer, it being possible, in turn, for these data to be determined and supplied to the fieldwork computer via sensors. The quality and information content of the context profile may be improved via the provision of a plurality of data collection devices, and via the incorporation of data collected therewith in the determination of a context profile.

The present invention may be expanded upon in that the following collected data, at the least, are processed further to form the context profile: The identity, position, and operating state of an agricultural machine, and time information.

If, at the least, data on the identification, geographic position, and the operating state of an agricultural machine, and time information are available, they may be used, according to the present invention, to derive a context profile that interprets these data with reference to context processing rules. A context profile derived from these data advantageously provides information on a context of the agricultural machine that makes it possible to draw relevant conclusions on the processes to be implemented in this context. Time information may be, e.g., time stamps, based on which it is possible to derive lengths of time, e.g., that were required for processing or hauling.

Furthermore, a context profile may be characterized by the fact that higher-value information is obtained via the processing and/or supplementation of the collected data. In the first example mentioned above, this higher-value information may be that the position of the combine harvester is compared to the position of a field to be harvested, with the conclusion being drawn that the combine harvester is approaching a field to be harvested. The context interpretation may include a calculation of the length of time that the combine harvester requires to reach the field. Furthermore, the context interpretation may be to determine the performance of the combine harvester based on its identification, and to compare it to the performance required for the field to be harvested. A context profile may therefore contain the information that a certain identified combine harvester is ready to harvest a certain field at a certain time.

In the second example described above, a higher-value context profile may also contain information regarding which field operating time of the forage harvester exists when the process time is summed together with additional, previously determined field operating times to obtain one overall field operating time. Based on this context profile, the process information may be selected, e.g., using process assignment rules, that states that maintenance should be carried out when a maximum field operating time of the forage harvester has been attained or exceeded.

The present invention may also be enhanced by further processing the following collected data to form the context profile: Operating parameters of an agricultural machine and/or performance characteristics based on the agricultural work or service, and/or material properties such as properties of a crop material and/or a material to be processed, and/or environmental information, e.g., agrometeorological data, and/or the identity, and/or position, and/or operating state, and/or operating parameters of one or more agricultural machines.

In the enhancement according to the present invention, the collected data and/or the data to be collected therefore include the additional data mentioned above. The step of collecting additional data may advantageously increase the evaluability and information content of context profiles derived therefrom.

This is advantageous, in particular, in terms of the unique character of agriculture, namely that the cost effectiveness and efficiency of agricultural work or service, and qualities such as the quantity and quality of the agricultural products that are created and processed depend not only on the agricultural machines that are used, and on their interaction with one another, but also on complex, natural factors that cannot be influenced. This results in strong fluctuations in terms of material properties, e.g., of the crop material to be processed, or of the cultivated field or the ground, and in terms of the environment, e.g., the current weather conditions. It is therefore preferable to also collect data on the material properties and/or the environment. Since the method according to the present invention relates equally to harvesting work and other types of work, the term “material” in the sense of the present invention therefore relates to crop material and to the output of harvesting work, such as grain or green crop material, and to material to be processed by performing work, such as ground to be worked, or plants to be fertilized. A material in the sense of the present invention may also be a material required to perform agricultural work or service, such as water, fertilizer, dung, or seeds. The material properties may be registered, e.g., before, during, or after material is processed, and/or during the further processing of the material.

To monitor the success of an agricultural enterprise, it may be interesting to ascertain performance characteristics related to the agricultural work or service, so that conclusions may be drawn regarding the cost effectiveness or efficiency of the agricultural work or service that was performed. Performance characteristics of this type that relate to agricultural work or service may be, e.g., effectiveness and productivity characteristics of agricultural machines, and/or comparable costs required to complete the agricultural work or service.

Operating parameters may be, e.g., the height or length of cut of a forage harvester, or the cylinder or rotor speed of a combine harvester.

In a particularly advantageous manner, the context profile of an agricultural machine may also contain information that presents an agricultural machine in relation to other agricultural machines, and that makes it possible to select process information that enables these agricultural machines to interact with one another. In particular, it is preferable to have the capability to also collect data from one or more additional agricultural machines. These data may be used to advantage to coordinate the participants, e.g., in a harvesting chain.

The present invention may be enhanced in that the context processing rules include: Supplement the collected data and/or further process the data using an algorithm, and/or compare the data to expected data, and/or derive higher-value information from the collected and/or supplemented data.

Collected data may also be supplemented with additional data in a manner to be explained below, in order to obtain a higher-value context profile. It is particularly advantageous to derive higher-value information when the data are related to one another and to thereby ascertain additional findings regarding the context. If the collected data are incomplete or faulty, it is also advantageous to supplement the collected data.

According to the present invention, the collected data may be supplemented and/or processed further, e.g., using an algorithm. An algorithm may be, e.g., a handling specification for deriving a context profile from the collected data, and/or that describes what additional data must be collected in order to create a context profile. The algorithm may be specified, e.g., by a central system or a user, and it may be modified as necessary.

Furthermore, according to the present invention, the process of further processing and/or supplementing the collected data to form a context profile using context processing rules may include comparing the collected data to expected data, and, preferably, combining the collected data to form higher-value context information depending on the level of agreement between the collected data and the expected data. It is furthermore preferable for the expected data to be specifiable, e.g., by a central system and/or user input.

Therefore, expected data in the sense of the present invention are preferably specified data, and they also preferably define the band width within which the collected data may occur. Depending on which data are collected, they agree with the various expected data. The context processing rules determine which higher-value context information are derived from the collected data and are processed and/or supplemented to form context profiles, depending on whether and with which expected data the collected data agree. This enhancement has the advantage that the context processing rules may be adapted to specific requirements in agriculture and to individual agricultural enterprises, thereby enabling the interpretation of collected data to form context profiles to be adapted to particular and/or changing requirements in agriculture in general, or to individual agricultural enterprises.

Higher-value information may also be obtained by supplementing the collected data, and/or by relating the collected data to other data. The data collected regarding the geographical position of a forage harvester may be processed, e.g., to form the context information that the forage harvester will be occupied for the next two hours with harvesting the rest of the field, provided that the current conditions persist. A higher-value context profile that has been supplemented with agrometeorological information may contain, e.g., the information that the field must be harvested within one hour, because a storm is coming. The process information derived from this higher-value context profile may also state that the ground speed should be increased, even though more energy will be consumed, in order to harvest the field in the time remaining until the storm comes.

The present invention may also be enhanced in that the data are supplemented by collecting supplemental data, preferably from another agricultural machine, a central system, a service provider, an application, in particular a farm management application, the Internet, and/or a user input.

Preferably, the further processing and/or supplementation of collected data to form a context profile using context processing rules includes collecting supplemental data from the stated sources, and combining the collected data with the supplemental data to form higher-value context information.

Supplemental data in the sense of the present invention are data that are used in addition to data that are collected directly, in order to derive context profiles. Supplemental data are, e.g., event information, obstacle information, agrometerological data, and/or data that are collected and made available by other units, such as other agricultural machines.

Supplemental data may be actively transmitted, e.g., by a central system to an agricultural machine, or they may be requested of an agricultural machine by a central system. In the same manner, it is also preferable, according to the present invention, for data transmission or a request to take place between two or more agricultural machines. If certain information which may change the context of (another) agricultural machine is present, e.g., in a central system or an agricultural machine, it is preferable that this information be actively transmitted. This information is then preferably used to generate an updated context profile, based on which it is possible to select modified process information.

In addition to the further processing of collected data, supplementing the collected data is likewise a particularly preferred form of deriving context profiles from the collected data. The information content of collected data may be increased considerably in combination with other data that have been collected from external sources.

In the second example described above, information, e.g., on the type and position of certain obstacles, or regarding the type of weather change expected, and when, may be used, e.g., in combination with the detected position of a combine harvester, to form a context profile that identifies a certain area yet to be harvested, and which must be harvested within a certain amount of time before the next storm comes. Process information derived from this context profile calls for, e.g., a higher ground speed of the combine harvester—possibly in exchange for a higher grain loss—than does context information derived from a context profile without the supplemental agrometeorological information regarding the approaching storm.

It is particularly preferrable to have access to various and preferably several sources from which to collect the supplemental data. For the case in which certain collected data are not available, or they are incomplete or faulty, it is furthermore preferable that these data be supplemented.

The present invention may also be enhanced in that the context processing rules are dependent on a specified objective, preferably on an issue related to machine control, safety, business operations, work, and/or information.

This enhancement according to the present invention is based on the idea that the quality and information content of context profiles are particularly high when the data are related to one another in a certain manner using context processing rules. In terms of the work-related question as to how long it will take to harvest the rest of a cultivated field, the ground speed of a combine harvester must be processed differently than it would be when dealing with the machine control-related question as to whether the ground speed is set at an optimal level in order to minimize the grain loss. When considering cost-effectiveness, the ground speed may be related to fuel consumption. When dealing with a safety-related issue, the ground speed may be related to the geographic position (e.g., field, road, farm) and the ground speed that is permitted under those particular circumstances. When dealing with an information-related issue, the ground speed may be documented relative to the position and/or working position of an agricultural machine.

The present invention may be enhanced in that the agricultural process information includes: The initiation, continuation, modification, interruption, and/or termination of a process and/or the performance of agricultural work or service, and/or operating parameters for performing agricultural work or service, and/or the collection of data while performing agricultural work or service, and/or the control of information flows.

In particular, it is preferable that a process performed by the agricultural machine be initiated, continued, modified, interrupted, and/or terminated depending on the context profile. The start and end, and modification of agricultural work or service or a process for performing agricultural work or service or a portion thereof likewise depends on the context. It is therefore preferable to make the execution of a process by the agricultural machine dependent on the context profile. Initiating a process means starting a process. An interruption differs from a termination in that, after a process has been interrupted for a possibly unknown length of time, it may be restarted using the same process parameters.

It is thereby preferable for the following steps to be carried out: Store the data collected while agricultural work or service is performed, and/or transmit the data collected while agricultural work or service is performed to another agricultural machine, a central system, and/or an application, in particular a farm management application. It is preferable for the data collected while agricultural work or service is performed to remain available, particularly in terms of documenting and calculating the output of agricultural work or service. The data may be stored for this purpose, and/or they may be transmitted to other systems, agricultural machines, or applications. The data may also be transmitted, e.g., to other service providers, or via the Internet.

It is furthermore preferred to also control the information exchange of an agricultural machine with one or more other agricultural machines and/or with a central system, and/or to control the related information flows depending on the context profile.

According to the present invention, process information will continue to be provided that indicates which types of agricultural work or service must be performed, and which process parameters should be used. The process information also indicates which data should be collected while the agricultural work or service is performed. For example, the process information may state that a field should be harvested and that this should be accomplished by a combine harvester traveling at a certain ground speed, and while collecting information on grain loss. The process information may further indicate, e.g., which data should be stored, documented, and/or forwarded in order to enable accounting to take place in an automatic manner that is tailored to the particular task and contractor.

The present invention may be enhanced in that the process assignment rules include: Select process information using an algorithm and/or select process information using reference context profiles, and/or select process information based on pattern and/or object recognition.

An algorithm may be, e.g., a handling specification stating which context profile should be used as the basis for selecting which process information. The algorithm may be specified, e.g., by a central system or a user, and it may be modified as necessary.

The selection of process information using process assignment rules and depending on the context profile, in particular reference context profiles, preferably includes: Providing a plurality of agriculture-specific reference context profiles, in which case the reference context profiles have a data structure that corresponds to the context profile, and in which the process information is assigned to the reference context profiles, comparing the context profile to the reference context profiles, and selecting the process information assigned to the reference context profile if the context profile agrees with one of the reference context profiles.

Particularly preferably, a selection made using process assignment rules is carried out based on reference context profiles. Reference context profiles are context profiles that typically occur, and for which it is determined which process information may be considered for this context profile. Advantageously, a large number of reference context profiles is created. If a certain context profile is now determined, the reference context profile that agrees with the context profile may be determined, according to the present invention, by comparing this context profile to the reference context profiles. The process information assigned to this conforming reference context profile is now the process information to be selected for the context profile. It is preferable for the reference context profiles to correspond to the context profiles in terms of their data structure, i.e., in terms of the type of data they contain, in particular to enable and/or simplify the comparison—according to the present invention—of context profiles and reference context profiles.

In the sense of the present invention, pattern and object recognition includes, e.g., recognizing process patterns in this context. It is particularly advantageous when missing context information and/or only partially conforming context information may be assigned, using pattern or object recognition, in a reasonable manner, even when context profiles are incomplete or faulty, thereby making it possible to select relevant process information even for a context profile that is incomplete or faulty.

The present invention may be enhanced in that the agriculture-specific process information is selected from among a plurality of agriculture-specific process information. Preferably, a large amount of agriculture-specific process information is made available, from which the process information that applies for a certain context profile may be selected.

The present invention may be enhanced in that the large amount of agriculture-specific process information is selected depending on an initial context from among a larger amount of process information, and the initial context is a certain context profile.

According to the present invention, it is particularly preferred that the collected data be further processed and/or supplemented to form an initial context. To this end, a context profile may be defined as the initial context, e.g., at a certain point in time and depending on a certain event, and the large amount of agriculture-specific process information that is provided is selected, depending on the initial context, from among a larger amount of process information.

This type of enhancement has the advantage that only that process information is provided for the method according to the present invention that may apply under certain basic conditions, i.e., the initial context. For example, a combine harvester, the initial context of which includes its being identified as a combine harvester, does not require any process information on attachments that may only be combined with a tractor, nor on the tasks that may be performed therewith. It is therefore preferable that only that quantity of process information is selected and made available, depending on the initial context, from among a totality of process information and/or from among a larger amount of process information that is relevant to the actual initial context, e.g., of an agricultural machine.

The present invention may be enhanced in that the initial context is transmitted from an agricultural machine to a central system, and that the large amount of agriculture-specific process information selected from among a larger amount of process information depending on the initial context is transmitted from the central system to the agricultural machine.

According to the present invention, it is particularly preferable that the initial context is transmitted from an agricultural machine to a central system, and that the large amount of agriculture-specific process information selected from among a larger amount of process information depending on the initial context is transmitted from the central system to the agricultural machine. It is particularly preferable when the totality of process information and/or a larger amount of process information is stored in a central system which may communicate with an agricultural machine. The agricultural machine preferably sends its initial context to the system and receives therefrom the large amount of process information that is relevant to the particular initial context.

This type of enhancement has the further advantage that the process information may be updated in the central system, thereby ensuring that the process information transmitted to various agricultural machines based on the initial context is always current. As a result, it is possible to avoid performing agricultural work or service based on outdated process information, and to avoid the expense required to update the database in a plurality of agricultural machines. Furthermore, it is advantageously possible to prevent the need to manually transfer process information to an agricultural machine, e.g., using a chip card or by connecting a laptop computer. The preferably autonomous communication of the agricultural machine with the central system, and the preferably likewise autonomous transmission of the initial context with receipt of the associated context information results in advantageous automation which greatly simplifies the performance of agricultural work or service and results in efficiency gains.

The present invention may be enhanced in that the following steps, at the least, are carried out repeatedly: Collect data, and further process and/or supplement the collected data using context processing rules, to form a context profile. Since the environment, basic conditions, and, generally, the context information typically change on a frequent if not continual basis while agricultural work or service is performed, it is particularly preferable for the context profile to be created not just once, but several times, and for the process of collecting data therefore be carried out not just once, but several times. It is particularly preferable for these steps to be repeated on a regular basis, e.g., at certain time intervals. It is also preferable for the steps to be repeated depending on certain events or depending on user input.

A further preferable enhancement of the present invention is characterized by the step: Compare the context profile to a previously determined context profile; the further preferable enhancement of the present invention is furthermore characterized by the fact that, if the context profile deviates from the previously determined context profile, the following steps are performed: Select process information using process assignment rules and depending on the context profile, and perform agricultural work or service depending on the selected process information. This type of enhancement is directed to recognizing changes in the context and, if context changes occur that may be recognized in the context profile, to select the relevant process information that is now current since the change was implemented, and to control the agricultural machine accordingly. This is particularly advantageous, since a change in the process information to be implemented may be connected to a context change, and it is therefore preferable to select the process information anew every time the context has changed. This requirement for process information depending on context changes may be referred to as the “pull” principle.

Event information may also be used to generate an updated context profile, based on which it is possible to select process information anew. A related use of event information may comprise the following steps, for instance: Transmit event information from a central system to an agricultural machine, select process information depending on the event information, and control the agricultural machine depending on the selected process information. This type of enhancement may also be referred to as the “push” principle. In this case, information on certain events that may change the context of an agricultural machine is contained in a central system, and it is preferably transmitted to the agricultural machine, based on which process information that is dependent on this event information is selected.

A further preferred enhancement of the present invention is characterized by the steps: Display the context profile and/or the selected process information, and, possibly, output a signal and/or prompt the user to release the context profile and/or the selected process information, and/or provide a way for a user to change the context profile and/or the selected process information.

The method according to the present invention makes it possible to largely automate the performance of agricultural work or service. Although this automation is desirable, for reasons of efficiency in particular, it may be of further advantage to display information on the processes and/or to output related optical or acoustic signals to the user. It may be furthermore preferred to prompt a user to release process information that was selected automatically, or to provide him with the option of changing this selected process information. In this manner, it is advantageously made possible for a user to monitor the automated performance of agricultural work or service.

Further advantageous embodiments of the method according to the preferred invention result from the combination of preferred features presented herein.

A further aspect of the present invention is the use of the method according to the present invention, and/or its enhancements in an agricultural application, in particular in an agricultural machine.

The following preferred method, according to the present invention, for supporting the automation of agricultural work or service is based on an agricultural machine and comprises the following steps:
Control functions of an agricultural machine depending on process information,
Collect data, the collected data including, at the least: The identity of the agricultural machine, the geographical position of the agricultural machine, the operating state of the agricultural machine, and time information,
   characterized by the steps:
Further process and/or supplement the collected data using context processing rules, to form a context profile,
Provide a majority of agriculture-specific process informations, the process informations stating, at the least: The agricultural work or service to be performed, and the process parameters required therefor, and the data to be collected while the agricultural work or service is being performed, these data to be collected including, at the least: The identity of the agricultural machine, the geographical position of the agricultural machine, the operating state of the agricultural machine, and time information,
Select process information using process assignment rules and depending on the context profile, and
Control the agricultural machine depending on the process information that was selected.

Further advantageous embodiments of this method according to the preferred invention result from the combination of the preferred features presented above. In terms of the advantages and details of this method and its enhancements, reference is made to the above-described, related aspects of the particular features.

A further aspect of the present invention is an agricultural machine of the type described initially, characterized by a data processing device which is designed to further process and/or supplement the collected data using context processing rules, and by a selection device which is designed to select process information using process assignment rules and depending on the context profile, and to transmit it to the control unit.

Particularly preferably, the agricultural machine includes a control unit which is designed to perform agricultural work or service based on process information, and one or more sensors which are designed to register the following data, at the least: The identity of the agricultural machine, the geographical position of the agricultural machine, the operating state of the agricultural machine, and time information, characterized by
a data processing device which is designed to further process and/or supplement the collected data using context processing rules, to form a context profile,
a selection device having a large amount of agriculture-specific process information, the process information stating, at the least: The agricultural work or service to be performed, and the process parameters required therefor, and the data to be collected while the agricultural work or service is being performed, these data to be collected including, at the least: The identity of the agricultural machine, the geographical position of the agricultural machine, the operating state of the agricultural machine, and time information,
and wherein the selection device is designed to select process information using process assignment rules and depending on the context profile, and to transmit it to the control unit.

A further aspect of the present invention is a system of the type described initially, characterized by a large number of agriculture-specific process information, the process information being assigned to one or more initial contexts, and by a selection device which is designed to select, depending on an initial context received from an agricultural machine, a large amount of process information assigned to this initial context from among the large amount of agriculture-specific process information, and to transmit it to the agricultural machine from which the initial context was received.

Particularly preferred is a system for supporting the automation of agricultural work or service, comprising a transmitter unit and a receiver unit which are designed to communicate with one or more agricultural machines, characterized by
a large amount of agriculture-specific process information, the process information stating, at the least: The agricultural work or service to be performed, and the process parameters required therefor, and the data to be collected while the agricultural work or service is being performed, these data to be collected including, at the least: The identity of the agricultural machine, the geographical position of the agricultural machine, the operating state of the agricultural machine, and time information,
and wherein the process information is assigned to one or more initial contexts, in which case an initial context includes, at the least: The identity of an agricultural machine, the geographical position of an agricultural machine, the operating state of an agricultural machine, and time information,
a selection device which is designed to transmit, depending on an initial context received from an agricultural machine, a large amount of process information assigned to the initial context, to the agricultural machine from which the initial context was received.

The agricultural machine according to the present invention, and the system according to the present invention have features that make them particularly suitable for use with a method according to the present invention, and with its enhancements.

In terms of the advantages, embodiments, and details of this agricultural machine, this system, and the particular enhancements, reference is made to the above-described, related aspects of those methods and enhancements that are relevant to the system and/or the agricultural machine.

Preferred embodiments of the present invention are described with reference to the attached figures.

### BRIEF DESCRIPTION OF THE DRAWINGS

FIG. 1 shows a schematic illustration of an application of the method according to the present invention,

FIG. 2 shows an overview of the central system and the on-board system depicted in FIG. 1,

FIG. 3 shows four examples of context profiles of a self-propelled forage harvester.

### DESCRIPTION OF THE PREFERRED EMBODIMENTS

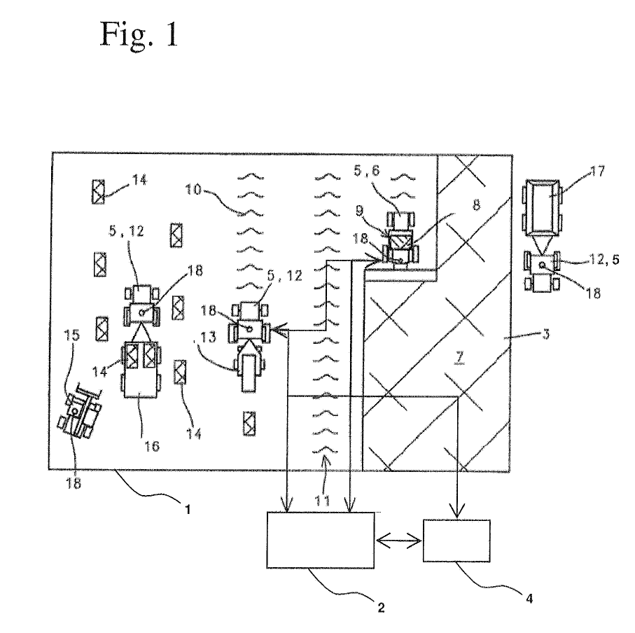

FIG. 1 is a schematic illustration of an application of the method according to the present invention using the example of agricultural work or service, namely harvesting a cultivated area 3 of a field 1, and retrieving the crop material. One or more agricultural machines designed as combine harvesters 6 first harvest stand 7 which grew in a cultivated field 3. The crop is stored for the interim on combine harvester 6 in a grain tank 9. The remaining part of the crop material, i.e., straw 10, is set down in swaths 11 on cultivated field 3 which has been harvested. A baling press 13 drawn by a tractor 12 presses straw 10 into bales 14 which are set down on cultivated field 3 which has been harvested. Bales 14 are loaded, e.g. using a stacker truck 15 onto flatbed trailers 16 pulled by tractors 12, and they are hauled away to be placed in storage. Fruit 8 stored for the interim in grain tank 9 is taken by hauling trailers 17 drawn by tractors, and is hauled away to be placed in storage or to be processed further. Various agricultural machines 6, 12, 15 include transmitter/receiver units 18 with which they may communicate with other agricultural machines 6, 12, 15 and/or with a central system 2, and/or with external data sources 4, such as a farm management system or the Internet. Transmitter/receiver units 18 may typically also receive GPS signals, which are used, e.g., to generate data on the geographic position of agricultural machine 6, 12, 15. Furthermore, agricultural machines 6, 12, 15 include on-board systems 5, using which they may further process the collected data in a manner to be described in greater detail below.

The method according to the present invention, which is used to support the automation of agricultural work or service, is explained below using a combine harvester 6 as an example. Combine harvester 6 may determine its geographic position using GPS signals received using its transmitter/receiver unit 18. Furthermore, combine harvester 6 may determine its operating state, which, in FIG. 1, is that of harvesting of cultivated field 3. Combine harvester 6 also registers time information, e.g., a time stamp, which may be included with the additional data that is collected. Combine harvester 6 also collects, e.g., data on the fill level of its grain tank, using a sensor. Combine harvester 6 may collect external information, e.g., the identity, geographic position, and operating state of agricultural machines 12, 15 located in its vicinity.

A context profile may be created based on these collected data and in conjunction with the identity of combine harvester 6. This context profile depends on the characteristic value of the data that were collected. If, as depicted, for instance, the operating state is that of harvesting a cultivated field 3, and grain tank 9 has a certain fill level, then the context profile may contain, e.g., the higher-value information as to whether the fruit of the rest of cultivated field 3 that has not yet been harvested will fit in grain tank 9 or not. If the fruit of the rest of cultivated field 3 which has not yet been harvested will fit in grain tank 9, then the context profile of combine harvester 6 would therefore contain the information, e.g., that the harvesting of cultivated field 3 will continue without initiating a process to transfer the load. If the fruit of the rest of cultivated field 3 which has not yet been harvested will not fit in grain tank 9, then the context profile of combine harvester 6 would therefore contain the information, e.g., that a load-transferring process is required.

If tractor 12 and hauling trailer 17 now enter the process chain, then tractor 12 may transfer various information to central system 2. Communication rules may be used which ensure, e.g., that data is transferred (e.g., to the central farm management system) on a regular basis (e.g., every day at 10:00 a.m.).

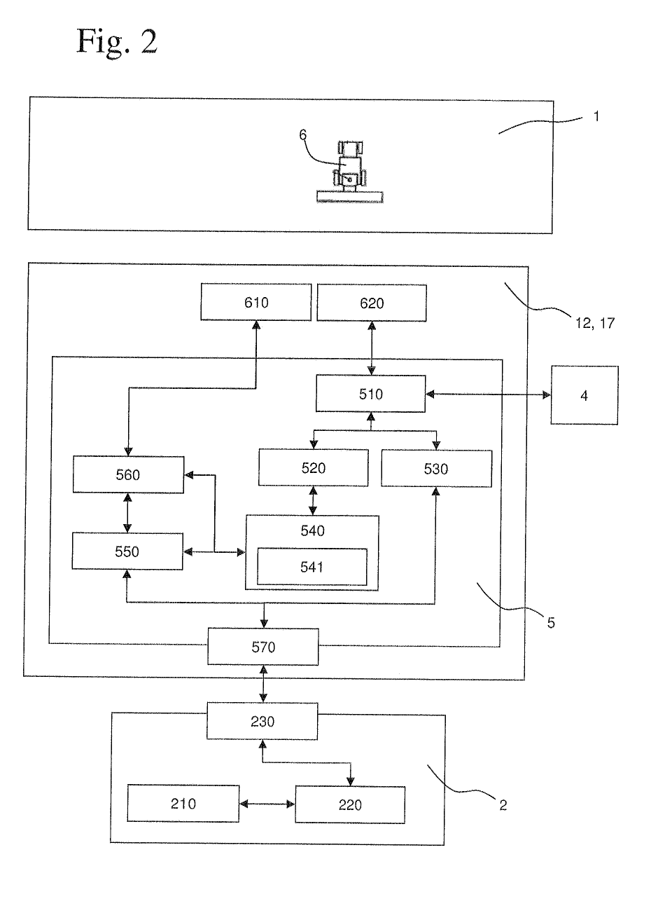

As shown in FIG. 2, tractor 12 may initially generate, with reference to context processing rules 510, an initial context 530 which is composed, at the least, of identity, geographic position, and operating state, and time information. The data for this purpose are registered via sensors 620, and/or they are supplemented with data from an external data source 4. Tractor 12 may transfer initial context 530 to central system 2 using transmitter/receiver unit 570.

A large amount of process information 210 is stored in central system 2. Depending on initial context 530 transmitted from tractor 12, a selection unit 220 selects, from among the large amount of process information 210, that process information which may be relevant for tractor 12 having actual initial context 530, and transfers it using transmitter/receiver unit 230 to on-board system 5 of the tractor, where it is made available as a large amount of process information 550.

When tractor 12 approaches field 1, its position changes, and so does its context profile 520. Context profile 520 of the tractor also includes, e.g., the information that a combine harvester 6, the grain tank of which needs to be emptied, is located on field 1.

Based on context profile 520 of tractor 12, process information 560 to be implemented is selected from available process information 550, using process assignment rules 540.

To this end, context profile 520 is compared with reference context profiles 541. If context profile 520 of the tractor contains the information that the tractor is located close enough to field 1 where combine harvester 6 to be unloaded is located, i.e., it may reach combine harvester 6 before the grain tank becomes completely full, then process information 560 is assigned to a related reference context profile 541 that states that a load-transferring process should be initiated. Selected process information 560 is transmitted to control unit 610 of tractor 12. The start position for the load-transferring process is determined depending on the distance yet to be covered, and on the ground speed of tractor 12 and combine harvester 6, and tractor 12 is directed to this position.

In this manner, it is possible, using the method according to the present invention, to at least partially automate the agricultural work or service of harvesting a cultivated field in that agricultural machines—combine harvester 6 and tractor 12 with hauling trailer 17—autonomously create context profiles 520 based on the data they have collected, and possibly based on external data they have collected, and they select process information 560 depending on context profiles 520. It is therefore possible to eliminate the step in which the operator of combine harvester 6 manually requests load-transfer support, followed by a manual disposition of a load-transfer vehicle 12, 17, e.g., by a land manager.

Furthermore, tractor 12 and combine harvester 6 may—depending on particular context profile 520—collect, document, store, and/or forward data on the performance of agricultural work or service, so that the work performed may be documented and accounted for in an automated manner, and to largely prevent the need for a user to manually record the data.

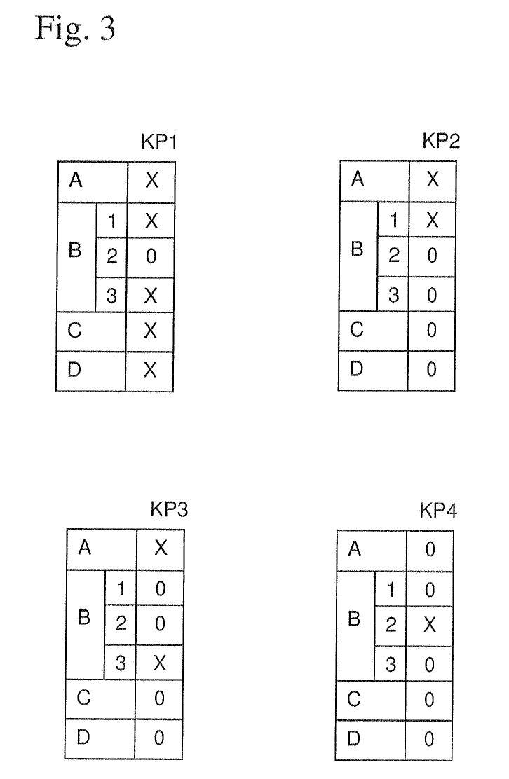

FIG. 3 shows four context profiles KP1-KP4 of a self-propelled forage harvester. Similar to combine harvester 6 in FIG. 1, the self-propelled forage harvester may be incorporated in a harvesting chain, e.g., a green crop material harvesting chain. Collected data A-D in context profiles KP1-KP4 are assigned characteristic value X for “yes”, or 0 for “no”.

A indicates whether the engine of the self-propelled forage harvester is running, or not. B represents data on the geographic position of the forage harvester: B1 stands for the position of the forage harvester on the field, B2 stands for the position of the forage harvester on the farm, and B3 indicates whether the speed of the forage harvester is greater than 0, i.e., whether or not the forage harvester is moving. C indicates whether the main drive of the forage harvester is switched on, or not. The main drive is the drive that must be switched on for work to be performed. Finally, D indicates whether the working position of the forage harvester is switched on, or not. The working position is the position of the front attachment or the combine-mounted devices that must be attained for work to be performed. Data A, C, and D therefore represent the operating state of the forage harvester. All of the data are provided with a time stamp.

Context profile KP1 stands for the context “field operating time”, in the special process time, since the forage harvester is located on the field (X at B1), is moving with the engine switched on (X at A and B3), and that the main drive and working position are switched on (X at C and D). The process information to be selected for this context profile may be, e.g., the collection, storage, evaluation, and/or forwarding of operating parameters and/or material properties. A relevant operating parameter is, e.g., the length-of-cut setting, and a relevant material property is, e.g., the moisture content of the crop material.

Context profile KP1 also stands for the context “field operating time”, since the forage harvester is located on the field in this case as well (X at B1). In addition, the engine of the forage harvester is switched on (X at A). However, the main drive and the working position are switched off (0 at C and D), and the forage harvester is not moving (0 at B3). Context profile KP2 therefore stands for the standing time, as a special characteristic value of the field operating time. The process information for this context profile may include, e.g., the collection, documentation, storage, and/or forwarding of the duration of the field standing time, in order to account for or discount the standing time, e.g., in an accounting procedure, depending on the accounting mode.

Context profile KP3 stands for the “street time” of the forage harvester, since it is not located on the field (0 at B1) or at the farm (0 at B2), but it is moving with its engine activated (X at A and B3). The process information for this context profile may state, e.g., that only the speed of the forage harvester should be registered, and not further operating parameters, in order to reduce the quantity of collected data to the greatest extent possible.

In contrast, context profile KP4 stands for the “farm time” of the forage harvester, since it is located on the farm (X at B2). In this case, the forage harvester is not moving (0 at B3), and the engine, main drive, and working position are switched off (0 at A, C and D).

Process information assigned to this context profile may contain, e.g., a message sent to a central system and/or to another agricultural machine stating that the forage harvester is available for use.

It will be understood that each of the elements described above, or two or more together, may also find a useful application in other types of methods and constructions differing from the types described above.

While the invention has been illustrated and described as embodied in a method for supporting the automation of agricultural work or service, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A method for supporting an automation of agricultural work or service, comprising the steps of collecting data; further processing the collected data using context processing rules to form a context profile; selecting process information using process assignment rules and depending on the context profile; and performing agricultural work or service depending on the process information that was selected.

2. The method as defined in claim 1, wherein said collecting the data includes at least partially using data collection devices in an agricultural machine.

3. The method as defined in claim 1, wherein said further processing the collected data to form the context profile includes further processing the collected data including at least: an identity, position, and operating state of an agricultural machine, and time information.

4. The method as defined in claim 1, wherein said further processing the collected data to form the context profile including processing the collected data including: operating parameters of an agricultural machine, and/or performance characteristics related to the agricultural work or service, and/or material properties, e.g., properties of a crop material and/or a material to be processed, and/or environmental information, e.g., agrometeorological data, and/or an identity and/or position and/or operating state and/or operating parameters of one or more additional agricultural machines.

5. The method as defined in claim 1, further comprising including in the context processing rules: supplement the collected data, and/or process the collected data further using an algorithm, and/or compare the data to expected data, and/or derive higher-value information from the collected and/or supplemented data.

6. The method as defined in claim 1, wherein said supplementing the data includes collecting supplemental data, preferably from another agricultural machine, a central system, a service provider, an application, in particular a farm management application, an Internet, and/or a user input.

7. The method as defined in claim 1, further comprising using as the context processing rules, rules that are dependent on a specified objective, preferably on an issue related to machine control, safety, business operations, work, and/or information.

8. The method as defined in claim 1, further comprising using as the agriculture-specific process information: initiating, continuing, modifying, interrupting, and/or terminating a process, and/or performing agricultural work or service, and/or operating parameters used to perform agricultural work or service, and/or collecting data while performing agricultural work or service, and/or controlling information flow.

9. The method as defined in claim 1, wherein said using the process assignment rules including using the rules: select process information using an algorithm, and/or select process information using reference context profiles, and/or select process information based on pattern and/or object recognition.

10. The method as defined in claim 1, wherein said using the agriculture-specific process information includes using the process information selected from among a large amount of agriculture-specific process information.

11. The method as defined in claim 10, wherein said using agriculture-specific process information selected from among a large amount of agriculture-specific process information includes using a large amount of agriculture-specific process information selected depending on an initial context from among a larger amount of process information, and the initial context being a certain context profile.

12. The method as defined in claim 11, further comprising transmitting the initial context from an agricultural machine to a central system, and transmitting the large amount of agriculture-specific process information selected from among a larger amount of the process information depending on the initial context from a central system to the agricultural machine.

13. The method as defined in claim 1, further comprising repeated performing the steps including the collecting data, and further processing and/or supplementing the collected data using context processing rules to form a context profile.

14. The method as defined in claim 1, further comprising comparing the context profile to a previously determined context profile, and if the context profile deviates from the previously determined context profile, selecting process information using process assignment rules and depending on the context profile, and performing the agricultural work or service depending on the process information that was selected.

15. The method as defined in claim 1, further comprising displaying the context profile and/or the selected process information, and, possibly outputting a signal, and/or prompting a user to release the context profile and/or selected process information, and/or providing a way for the user to change the context profile and/or the selected process information.

16. The use of a method as defined in claim 1, further comprising using the method as defined in claim 1 in an agricultural application, in particular in an agricultural machine.

17. A method for supporting an automation of agricultural work or service, comprising the steps controlling functions of an agricultural machine depending on process information; collecting data including at the least an identity of the agricultural machine, a geographical position of the agricultural machine, an operating state of the agricultural machine, and time information; further processing and/or supplementing the collected data using context processing rules to form a context profile; providing a large amount of agriculture-specific process information, including at least: the agricultural work or service to be performed and the process parameters required therefor; while the agricultural work or service is being performed including in the data to be collected: an identity of the agricultural machine, a geographic position of the agricultural machine, an operating state of the agricultural machine, time information; selecting process information using process assignment rules and depending on the context profile; and controlling an agricultural machine depending on the process information that was selected.

18. An agricultural machine, comprising a control unit performing agricultural work or service depending on process information; one or more data collection devices collecting data; a data processing device further processing and/or supplementing the collected data using context processing rules to form a context profile; and a selection device selecting process information using process assignment rules and depending on the context profile, transmitting it to the control unit.

19. A system for supporting an automation of agricultural work or service, comprising a transmitter unit and a receiver unit communicating with one or more agricultural machines; a large amount of agriculture-specific process information assigned to one or more initial contexts; and a selection device selecting, depending on an initial context received from an agricultural machine, a large amount of process information assigned to this initial context from among the large amount of agriculture-specific process information, and transmitting it to the agricultural machine from which the initial context was received.
